(19) United States
(12) Patent Application Publication
(10) Pub. No.: US 2005/0170983 A1
(43) Pub. Date: Aug. 4, 2005

(54) Comprehensive stain removal kit and method with absorbent backing material

(75) Inventor: John Mahdessian, Long Island City, NY (US)

Correspondence Address: OSTROLENK FABER GERB & SOFFEN, 1180 AVENUE OF THE AMERICAS, NEW YORK, NY, 100368403, US

(73) Assignee: MP Technologies

(21) Appl. No.: 11/093,566

(22) Filed: Mar. 30, 2005

Related U.S. Application Data
(63) Continuation of application No. 10/660,823, filed on Sep. 12, 2003, now abandoned.

(51) Int. Cl. C11D 17/04

(52) U.S. Cl. 510/277

(57) ABSTRACT

A comprehensive stain removal kit includes various cleaning formulas, rinses and a super absorbent cloth for a regimen of stain removal. A stain removal guide is included to provide a stain removal regimen based on a stain and fabric classification. Cleaning formulas and rinses are alternately applied to the fabric in the presence of the super absorbent cloth in combination in accordance with a specified stain removal regimen. The cleaning formulas and rinses are absorbed into the super absorbent cloth with the stain material to completely remove stains, including combination stains. The kit is provided as a portable packet easily used or stored in a variety of locations where stain removal may be desired.

### CROSS-REFERENCE TO RELATED APPLICATION

This is a continuation of U.S. patent application Ser. No. 10/660,823, filed Sep. 12, 2003 in the name of John Mahdessian and entitled COMPREHENSIVE STAIN REMOVAL KIT AND METHOD WITH ABSORBENT BACKING MATERIAL.

### FIELD OF THE INVENTION

The present invention relates generally to removing stains from fabrics, and relates more particularly to a kit and method for treating stains according to a specified criteria.

### DESCRIPTION OF THE RELATED ART

Stains and soaked-in spots on fabrics including apparel are often difficult to remove in a timely fashion or with given user requirements. For example, a person wearing a particular item of clothing that becomes stained will often not wish to or be able to submit the clothing item to professional cleaning services, which can be both time consuming and costly. Getting apparel to a cleaning service such as a dry cleaner can also take a large amount of time, during which time a stain is more likely to set and becomes harder to remove. The stain is more likely to set over a period of non-treatment because the stain material tends to oxidize and form bonds with the fabric over time and become increasingly more difficult to eradicate safely. Stain removal can be difficult because a number of other factors for satisfactory cleaning must be considered. For example, the type of stained material should be considered in selecting an appropriate technique for removing the stain. In addition, the fabric to be treated for stain removal should be considered to determine if an appropriate stain treatment may damage the fabric. It would be desirable to quickly and easily diagnose a stain and the stained fabric for an appropriate treatment to rapidly remove the stain without damaging the fabric.

One drawback in stain removal processes is that an applied stain removal agent can soak into the stained fabric and be dispersed into the fabric outside the area of the stain. The dispersion of the stain removal agent can draw the stain material into unstained areas of the fabric, creating a larger stain area and potentially discoloring a larger area of the fabric than is the case with the original stain. It would be desirable to provide a means for preventing dispersion of the stain removal agent outside an area of the stain and to focus the cleaning power of the stain removal agent in the stain area.

In addition, if the fabric is soaked with a cleaning formula and not rinsed out, the final results can be poor. For example, stain particles and cleaning formula residue can be left in the fabric if not rinsed out, which can have an adverse effect on the fabric, including leaving a ring around the stained areas.

Another drawback in stain removal that should be avoided is improper use of a cleaning agent that can result in further setting the stain into the fabric rather than removing it. Many cleaning agents have strict packaging and handling requirements, and require special application methods. It has often been the case that properly disposing of the cleaning agents or solvents is a sizeable task, often limited because of practical considerations to commercial dry cleaning establishments.

Attempts to provide cleaning agents for personal use in a simplified product have been disclosed in U.S. Pat. No. 2,980,941 to Miller, U.S. Pat. No. 3,686,125 to Miller and U.S. Pat. No. 3,993,190 to Schmidgall. These stain removing systems provide techniques for delivering a cleaning solution to a stained area for stain removal. These approaches provide a simplistic approach to removing a stain, however a given single cleaning agent may not be useful for all types of fabrics, or to remove all types of stained material, such as in the case of combination stains. In addition, there is no one universal cleaning agent that is effective in all stain group categories. In some cases, cleaning agents that are inappropriate to clean a given stain compound have an adverse effect on the stain by further setting it into the fabric.

Another approach to remove particular stain combinations in a number of different types of fabric is disclosed in U.S. Pat. No. 6,013,614 to Mahdessian, the entire contents of which is hereby incorporated by reference into the present application. Mahdessian discloses the use of alternate cleaning formulas and rinses to remove a variety of stains in a variety of materials according to a particular application sequence. The approach by Mahdessian works well in removing a number of types of stains because of the application of different cleaning formulas directed at different stain types responsive to the particular cleaning formula. According to this approach, complex stains can be removed with a particular cleaning formula sequence with rinses applied after each cleaning formula application. However, it would be desirable to improve this approach to overcome the drawback of cleaning formula and stain dispersion in the fabric to be cleaned.

U.S. patent application Publication No. U.S. 2002/0078510 to Lee, U.S. patent application Publication No. U.S. 2003/0060396 to Deak and U.S. patent application Publication No. U.S. 2003/0008799 to Barnabas et al. all disclose the use of a cleaning agent applied to one side of a fabric with an absorbent material applied to another side of the fabric. However, these stain removing techniques continue to suffer from the same drawbacks as those described above with a single cleaning agent in removing complex or combination stains.

### SUMMARY OF THE INVENTION

In accordance with the present invention, there is provided a stain removal regimen involving a prescribed series of cleaning formulas, with rinsing steps after each cleaning formula application in the presence of an absorbent material, such as a cloth, for example. The absorbent material may be of a type known generally as a super absorbent, which can readily saturate or absorb fluids. A number of different cleaning agents are provided for application to a stain, depending upon the type of stain and it's composition. The cleaning agents or formulas, are generally safe on most fabrics and properly set dyes. The cleaning formulas are applied in an appropriate sequence to obtain the best stain removal results. Rinse packets containing distilled water, for example, are provided to permit a rinse step after application of a cleaning formula to remove the collective cleaning formula and stain particles from the fabric material in the sequence of cleaning formula applications. A super absorbent cloth, for example, is applied to an opposite side of a fabric to which the cleaning formulas and rinses are sequentially applied. The super absorbent cloth collects the stain particles along with the cleaning formula. That is, the super absorbent cloth produces a flow through the fabric in the locality of the stain to enhance removal of the stain material.

The cleaning formulas are provided in sealed packets containing cloths that are saturated with the various cleaning formulas, for example. Similarly, the rinsing solutions are provided in a sealed packet with a cloth or web material to permit simple handling of the rinsing solution and application to the fabric. Multiple super absorbent cloths are also provided in a sealed packet, which can be opened to obtain fresh cloths, and used to store unused cloths. The cloths are not saturated with a liquid that may evaporate, so the super absorbent cloths need not be continuously sealed. The super absorbent cloths can be used in an initial step according to the present invention to absorb and remove excess stain particles and material to prevent spread of the stain, as well as during the stain removal process and at the end to assist in drying or removing excess rinse solution from the fabric. The super absorbent cloths help to offset or prevent any ring effect that may occur if stain particles, cleaning formula residue or minerals are dispersed or left to dry in the fabric.

The present invention also provides a guide to stain removal using the cleaning formulas to produce the best stain removal results. The guide is consulted based upon the stain type and fabric for selection of the cleaning formulas and their appropriate sequence of application. The cleaning formula packets, the rinse packets, and the super absorbent cloth packet, together with the stain removal guide, are incorporated together into a comprehensive stain removal kit that is compact and easily portable and can be used a wide variety of settings to quickly and easily remove stains from stained fabrics.

### BRIEF DESCRIPTION OF THE DRAWINGS

The present invention is described in greater detail below, with reference to the accompanying drawings, in which:

FIG. 1 is an exemplary illustration of the items comprising a kit according to the present invention;

FIG. 2 is an illustration of cleaning formula packet labeling according to an embodiment of the present invention;

FIG. 3A is an illustration of rinse packet labeling according to an embodiment of the present invention;

FIG. 3B is an illustration of absorbent cloth labeling according to an embodiment of the present invention;

FIG. 4 is an abstract flow chart indicating generalized examples of steps for application of the present invention to remove stains;

FIGS. 5A and 5B show general forms of stain guides according to the present invention;

FIGS. 6A and 6B show specific stain guide information for application of the present invention; and

FIG. 7 shows a complex stain removal process guide according to the present invention.

### DETAILED DESCRIPTION OF THE EMBODIMENTS

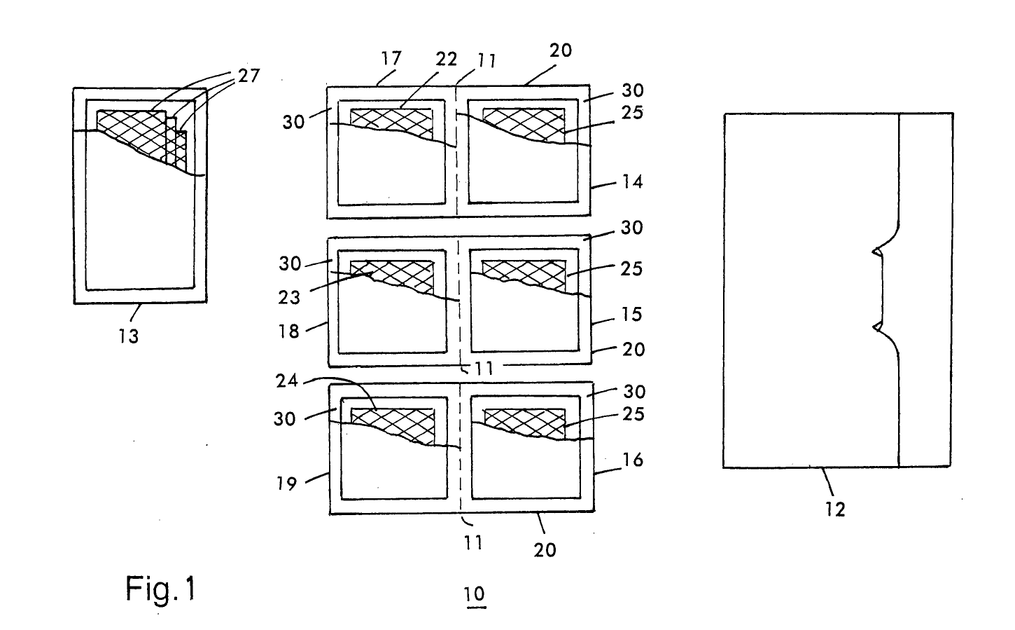

Referring now to FIG. 1, an illustration of an exemplary kit and components according to the present invention is shown generally as kit 10. Kit 10 includes an envelope 12 for holding the kit contents and providing guide instructions for use of the kit. Packet combinations 14-16 provide a combination cleaning formula packet and rinse packet for application to a stained fabric in accordance with the present invention. A packet 13 contains super absorbent cloths that are used with combination packets 14-16 in removing a stain. Packets 13-16 fit into envelope 12 to provide a compact and easy package for use as a stain removal kit and system.

When treating stained fabric, time is an important factor in successfully removing a stain from the soiled fabric. The sooner the stain is properly treated, the easier and safer it is to remove the stain. The longer a stain remains untreated, the sooner the stain material will oxidize and set into the fabric. Accordingly, stain removal kit 10 is made portable and compact to be taken along or stored in any location convenient to where a stain may be incurred.

In FIG. 1, three different cleaning formula packets are illustrated in combination with rinse packets shown as combination packets 14-16. Combination packets 14-16 are composed of two separate packets separated by a perforation 11, so that the special formula packet and the rinse packet can be separated and applied to a stained fabric separately. By providing combination packets 14-16, a rinse packet is conveniently accessible with the cleaning formula packet, so that a rinse can be applied conveniently after the cleaning formula is applied.

Combination packets 14-16 include cleaning formula packets 17-19, each of which includes an absorbent cloth 22-24, respectively, saturated with a separate cleaning formula. Preferably, three different cleaning formulas F1, F2 and F3 are available in cleaning formula pockets 17-19, respectively. For example, packet 17 includes cloth 22 saturated with a cleaning formula for cleaning earth based stains, such as, for example, fruit juices, teas, colas, liquors and so forth. Packet 18 includes a cloth 23 saturated with a cleaning formula for cleaning protein and dairy based stains, such as, for example, blood, perspiration, milk, eggs and so forth. Packet 19 includes a cloth 24 saturated with a cleaning formula for cleaning oil based stains, such as, for example, vegetable, mineral or petroleum oils, animal fat, salad dressings and so forth.

Each cleaning formula saturated into cloths 22-24, in packets 17-19, is accompanied by a rinse packet 20, generally referred to or labeled as R, that has a cloth 25 saturated with a rinsing agent. Preferably, the rinsing agent saturating cloth 25 is distilled water. However, it should be apparent that a number of rinsing agents are available for use with kit 10, and may be matched individually with the separate cleaning formulas in packets 17-19. For example, rinse packet 20 accompanying cleaning formula packet 17 in combination packet 14 can contain a rinsing agent that is specially formulated to rinse the cleaning formula saturated into cloth 22, and likewise for the other cleaning formulas and rinse packets.

A packet 13, generally labeled S, preferably includes three super absorbent cloths 27 that are used in conjunction with the application of the cleaning formulas and rinsing agents supplied with packets 17-20. It should be apparent that other types of absorbent material may be used in place of the super absorbent cloths. For example, absorbent cotton balls, pads, sponges and the like that are capable of absorbing fluid from a fabric can be used.

Super absorbent cloths 27 can be used as a first treatment for removing stain material from fabric. That is, cloth 27 can be applied initially to the stained fabric to soak up the stain material and remove excess stain material to reduce the amount of stain that must be cleaned. Cloth 27 is also applied to an opposite side of the stained fabric than that to which the cleaning formulas and rinsing agents are applied. By placing super absorbent cloth 27 on an opposite side of the stained fabric, application of the cleaning formulas and rinsing agents helps to transfer the stain material through the fabric and into super absorbent cloth 27. Super absorbent cloth 27 thus draws the cleaning formulas, the rinsing agent and the stain material through the fabric to be cleaned to help provide a mechanical flow for removal of stain material. In addition, the use of super absorbent cloth 27 tends to keep the stain from being dispersed further into the fabric. That is, super absorbent cloth 27 draws the cleaning formulas and rinses through the fabric, without a substantial amount of spread within the fabric. It is typically the case that application of conventional stain treatments cause the stain material to be dispersed into the fabric, resulting in a larger stain area. By using super absorbent cloth 27 in conjunction with careful application of the cleaning formulas and the rinsing agents, a stain can be contained to its original area without further spreading into the fabric.

Stain kit 10 also includes an envelope 12 for housing packets 13 and combination packets 14-16. Envelope 12 provides a pocket (not shown) for storing packets 13 and combination packets 14-16 in an easy to use and simple storage compartment. Envelope 12 preferably folds over several times to provide a compact carrying case for stain kit 10 with stain treating information and guides provided in several sections of envelope 12. In addition, envelope 12 is printed with instructions for using kit 10, in addition to providing a guide for stain removal, discussed in greater detail below.

Packets 13 and combination packets 14-16 are also preferably printed with identifiers and instructions for use. For example, packet 17 may be printed with an identifier for a cleaning formula 1, while packets 18 and 19 may be printed with identifiers for a cleaning formula 2 and 3, respectively. Packets 20 are preferably printed with a rinse identifier are for easily discerning the rinsing agent and its purpose from that of the cleaning formulas. Packets 17-19 are also preferably printed with instructions for application of the respective cleaning formula to the stained fabric.

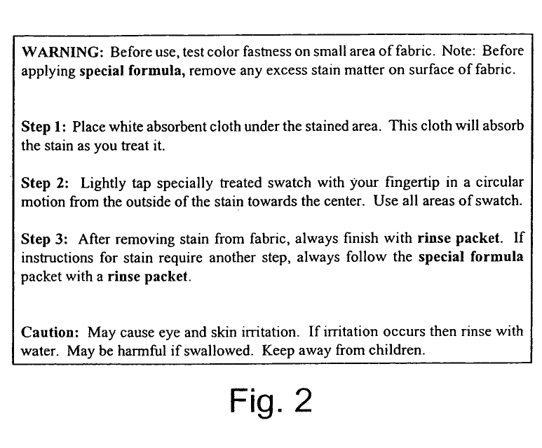

Referring now to FIG. 2, an exemplary illustration of printed instructions provided on an outside of each of packets 17-19 is shown. In addition to providing instructions for use, the packets printing also provides warning information for use with sensitive fabrics, as well as a caution for safe and proper use. The instructions call for absorbent cloth 27 to be placed on an opposite side of the fabric to be treated with the relevant cleaning formula.

The instructions on packets 17-19 also describe a preferable technique for applying the cleaning formula with any of cloths 22-24. In addition to containing the stain with the use of super absorbent cloths 27, the technique provided in step 2 of FIG. 2 helps to draw stain material towards a center of the stain, rather than spreading the stain material further into the fabric. According to this preferred application, the saturated cloth 22-24 is tapped lightly on the fabric in a circular motion around the edge of the stain and worked towards the center of the stain area. This technique releases cleaning formula into the stained fabric, while containing the stain in a small localized area. Step 2 also indicates that all areas of cloth 22-24 should be used in treating the state area. By using all areas of cloth 22-24, a stain material picked up in cloth 22-24 is not transferred into the fabric again or into other areas of the fabric. In addition, by using all areas of cloths 22-24, the relevant cleaning formula is supplied to the stained fabric is less contaminated with stain material than would otherwise be the case, resulting in better stain removal. The instructions in step 3 of FIG. 2 indicate that a rinse packet 20 should be used following the application of the cleaning formula in cloths 22-24. Cloths 25 are removed from rinse packets 20 and applied to rinse the fabric of the relevant cleaning formula and further provide a flow for the stain material to exit the fabric. Super absorbent cloth 27 also absorbs the supplied rinsing agent to further conduct stain material out of the stained fabric.

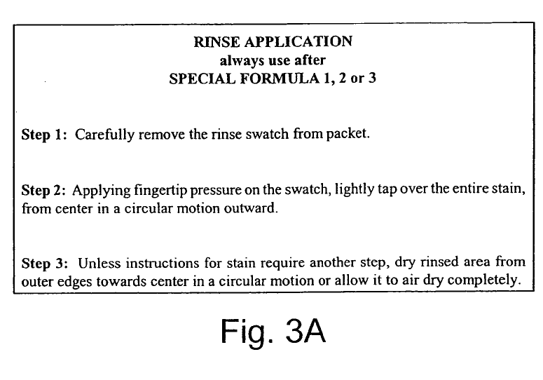

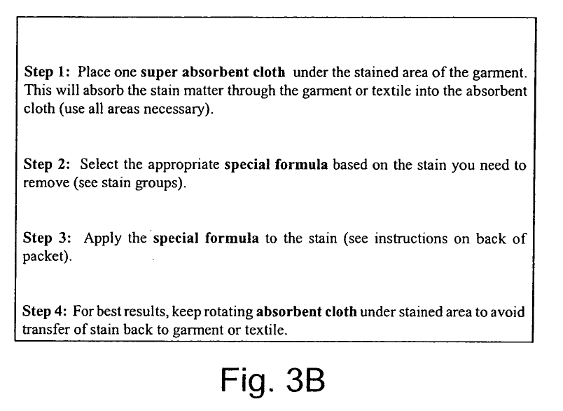

Rinse packets 20 also include instructions for use, an example of which is illustrated in FIG. 3. In accordance with step 2 of FIG. 3, cloth 25 saturated with the rinsing agent is applied to the stain area near the center, and worked over the entire stain in a circular pattern while moving towards the perimeter of the stain. If no other cleaning formulas are to be applied, another super absorbent cloth 27 is used to further dry the fabric area to remove the rinsing agent from the fabric.

Packet 13 also includes printed instructions and identification, indicating that the stain removal process should be started with the application of one of super absorbent cloths 27. Referring to FIG. 3B, several steps for use of super absorbent cloth 27 are illustrated. In accordance with step one of FIG. 3B, super absorbent cloth 27 is moved or rotated to permit all areas of super absorbent cloth 27 to be used to soak up cleaning formula, rinsing agent and stain material.

In accordance with a preferred embodiment of the present invention, the rinsing agent saturating cloths 25 is distilled water. Distilled water is helpful in flushing stain particles and cleaning formula from the stained fabric, and is easily absorbed into super absorbent pads 27. In addition, distilled water permits the fabric to dry without leaving a ring, such as would be the case with typical tap water containing iron and various other minerals. It is often the case that tap water used in a localized area of a fabric for rinsing will leave a yellow ring that is directly the result of iron and other minerals in the tap water.

To use stain removal kit 10, the stain guide is consulted to determine the appropriate cleaning formulas and sequence for removing the given stain. Super absorbent cloth 27 is placed on one side of the stained fabric.

Cleaning agents are then applied to another side of the stained fabric, for example, cleaning formula 1, 2 or 3 in packets 17-19, respectively, for example. Using these cleaning formulas in various combinations, any type of stain can be removed with excellent results. Cleaning formula 1 is preferably designed to remove earth based stains, while cleaning formulas 2 and 3 are designed to remove protein and oil based stains, respectively. These cleaning formulas are commercially available in proper dilutions and with appropriate additives suitable for direct contact with fabrics.

In an exemplary embodiment, cleaning agents 1, 2 and 3 are saturated into cloths 22-24, respectively. Since these cleaning formulas are typically applied in liquid form, the cloth or web material to be saturated is selected to avoid chemical interaction with the cleaning formulas, and to serve as a cleaning tool. For example, the cloth material is a non-woven, embossed applicator having a 3 to 1 rayon/polypropylene blend and is available under the trade name NOVONETTE sold by Veratec. The embossing on the applicator provides a textured surface that enhances mechanical cleaning action while providing recesses to contain soil material taken from the fabric surface being cleaned. Preferably, the same cloth material is used in packets 14-19. It should be apparent that other synthetic blends or treated natural fibers can be used for the cloth or web material.

In an exemplary embodiment, the packets themselves are created from laminates 30, which are cut into paired blanks and heat sealed along their peripheries. Any suitable vapor impervious laminate may be used that avoids chemical interaction with the cleaning formulas. Laminates 30 contain an outer paper layer, an intermediate foil layer and an inner modified polyethylene ionomer layer which is heat-sealable.

In an exemplary embodiment, rinse packets 20 preferably contain cloths saturated with distilled water. Packets 17-19 are labeled to indicate that rinse agents in packets 20 should be applied after the cleaning formulas. Packets 20 are labeled to indicate that super absorbent cloth 27 is used before and potentially after a complete sequence of cleaning formula applications and rinses, or the fabric may be air dried until completely dry. The labeling on packets 20 also indicates how super absorbent cloths 27 should be used, i.e., from outer edges of the wet area towards a center with circular motions (FIGS. 3A and 3B). Packet 13 is preferably labeled to indicate application prior to the use of the cleaning formulas, as well.

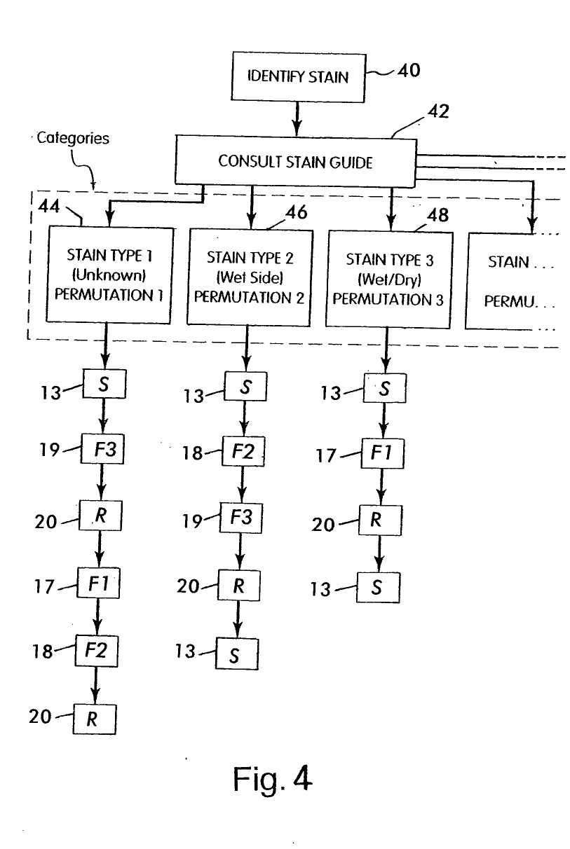

Referring now to FIG. 4, in an exemplary embodiment, use of the kit begins with identification of the stain in block 40 and obtaining the stain treatment from the stain guide in block 42. If the stain type is unknown, as shown in block 44, the packets are applied in the order of packet 19, 20, 17, 20, 18, 20, with super absorbent cloth 27 in place behind the stained fabric. Super absorbent cloth 27 is preferably positioned on an opposite side of the fabric that will be treated with the cleaning formulas and rinses according to the stain guide.

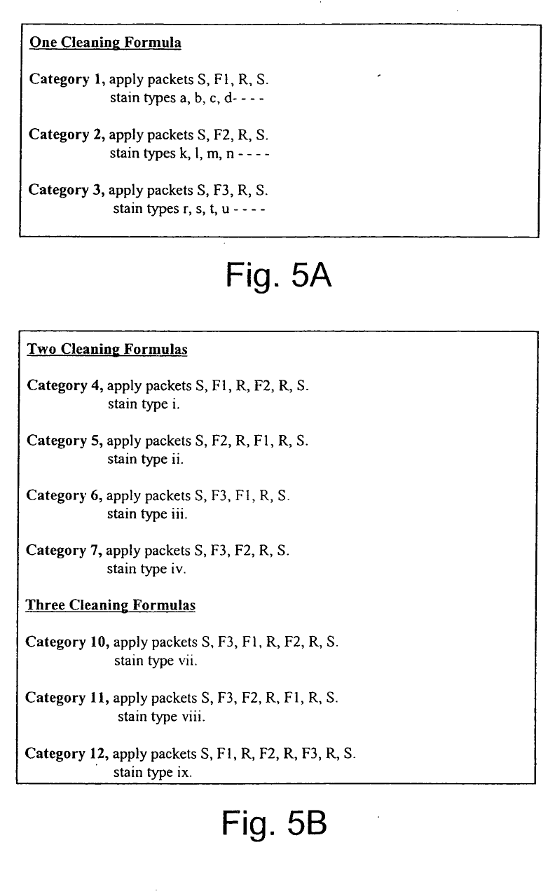

The stain guide lists a number of combination stains that are effectively treated with a specific sequence of cleaning formulas and rinses. For example, in block 46 a particular wet stain type calls for the application of packets 18, 20, 17, 20, 13 after placement of super absorbent cloth 27. A third stain type is treated with permutation 3 in box 48 by applying packets 17, 18, 20, 13 in the presence of super absorbent cloth 27. Many other stain types and permutations are provided as indicated in FIGS. 5A-5B. FIG. 5A illustrates a general form for a stain guide that calls for a single cleaning formula. For example, packets 17 and 18 call for the subsequent use of packets 20 after the application of each cleaning formula, and the further subsequent use of packet 13 to dry the fabric.

Referring now to FIG. 5B, in an exemplary embodiment, another portion of the stain guide is illustrated in a general form. The stains handled according to the applications in FIG. 5B include combination stains that are removable with two or more recommended cleaning formulas. For a combination stain, the stain guide contains detailed indications of each packet that is to be applied and the order of application. Note that it is possible to apply two cleaning formulas at once, followed by a rinse for both.

Super absorbent cloth 27 provides a means for absorbing not only stain material that is dissolved or loosened by application of one or more cleaning formulas and rinses, but also absorbs the cleaning formulas and rinses themselves. Accordingly, super absorbent cloth 27 soaks up the cleaning formulas, rinses and stain material to provide a fluid flow through and out of the stained fabric to obtain a mechanical means for removing stain material. As further solvent and or rinse is applied to the fabric, the flow through the fabric to super absorbent cloth 27 is enhanced, thereby contributing to removing the stain material from the fabric.

Moreover, super absorbent cloth 27 tends to prevent cleaning formulas, rinses and stain material from spreading further in the fabric. By drawing the cleaning formulas and rinses through the fabric, there is less of an opportunity for the dispersion of the cleaning formulas or rinses into the fabric. When the area of fabric absorbing the cleaning formulas, rinses, and potentially the stain material, is reduced, the stain removal process achieves increased effectiveness and produces better results.

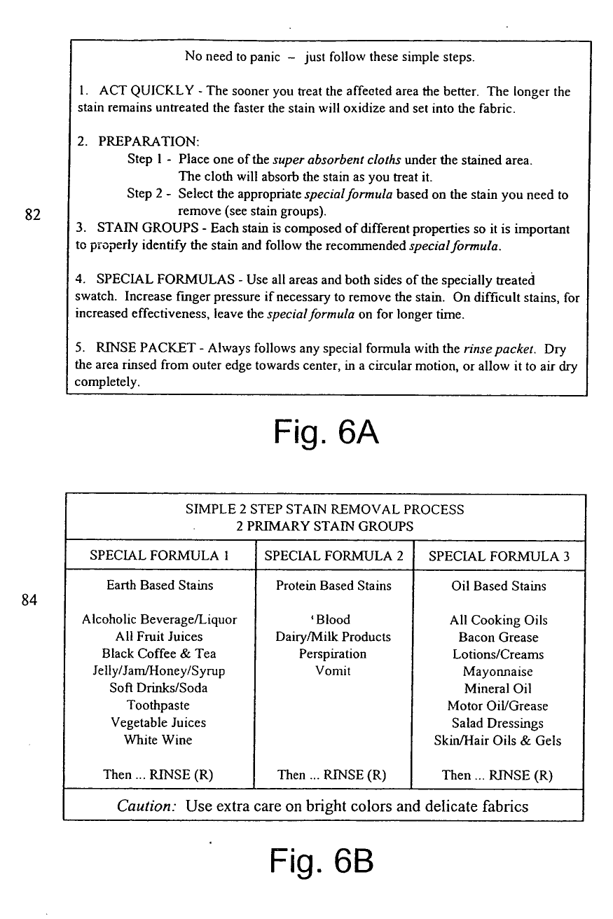

Referring now to FIGS. 6A-6B, further exemplary stain removal guides are illustrated as guides 82 and 84. A user simply follows the instructions for using the stain kit according to guide 82. Guide 84 illustrates the type of stains that are treated with each of the special formulas contained in the respective packets in the kit of the present invention.

As described in guide 82, cleaning a particular stain is addressed by applying super absorbent cloth 27 to one side of the stained fabric, selecting the appropriate packets indicated by guide 84 and sequentially opening and applying the packet contents to the side of the stained fabric opposite super absorbent cloth 27. The cloth or web from the selected packet is preferably lightly tapped in contact with the stained fabric, and super absorbent cloth 27 draws the cleaning formula, rinse and stain material through and out of the stained fabric. Once the fabric has been sufficiently saturated with the cleaning agent that is drawn through the fabric with the stain material, the used cloth or web is simply discarded and the next steps in the sequence are applied. If a combination stain is to be treated, i.e., one involving two or more materials listed in different columns of guide 84, a sequence of formula applications is called for.

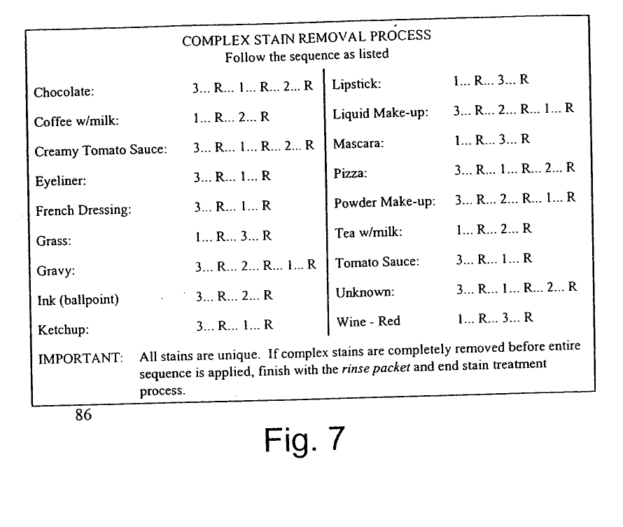

Referring now to FIG. 7, in an exemplary embodiment, a guide for a complex stain removal process is shown generally as a guide 86. Guide 86 is, for example, a package cover or label on packaging for a stain removal kit. An individual using guide 86 reviews the list of stains covered by the complex stain removal process to identify the stain to be removed and the process for removing the stain. If the stain is not listed, the complex stain is treated as an unknown stain and the unknown stain sequence is used. Alternately, the user can consult the items listed in guide 84 to determine if the unlisted complex stain can be treated as a combination of items in the different columns of guide 84.

For example, guide 84 (FIG. 6B) may list components of a complex stain in different categories that points to the application of a stain removal sequence provided in guide 86. In guide 84, a black coffee stain is removed with special formula 1, while milk is removed by application of special formula 2. Referring to guide 86, a stain consisting of coffee with milk is treated with the application of special formula 1, followed by a rinse step, and then special formula 2 followed by a rinse.

Guide 86 further notes that when treating a complex stain, the sequence of applications can be truncated if the stain is completely removed before the end of the sequence. Rinse packets are preferably applied after the cleaning formula applications to remove both the cleaning formula and any stain material remaining. The cleaning formulas, rinse material (preferably distilled water) and stain material are all absorbed by the super absorbent cloth to assist in fluid flow and stain removal throughout the treatment process. Used packets and the super absorbent cloth may be simply discarded after the treatment process.

By classifying the stain material and fabric to be treated, a self contained kit with three different cleaning formulas is provided, capable of cleaning all types of stains. The packets and guide are packaged together as a kit that is completely portable and suitable for transportation in a car, jacket, pocket, purse, or stored at home or office, or in a restaurant, hotel or other establishment in which ready treatment for stains is desired. The comprehensive stain cleaning kit achieves excellent cleaning results for all types of material and all stains.

Although the present invention has been described in relation to particular embodiments thereof, many other variations and modifications and other uses will become apparent to those skilled in the art. It is preferred, therefore, that the present invention be limited not by the specific disclosure herein.

1. A comprehensive stain removal kit, comprising:
at least one cleaning formula for cleaning a stained fabric;
a rinse solution for rinsing the fabric after application of the cleaning formula;
a stain guide including information of treatment of particular stains through the application of the cleaning formula; and
a super absorbent material for application to a side of the fabric opposite that to which a stain treatment is to be applied to absorb at least one of the cleaning formula with stain material and the rinse solution.

2. The comprehensive stain removal kit according to claim 1, wherein the at least one cleaning formula is an acidic cleaning agent.

3. The comprehensive stain removal kit according to claim 1, wherein the at least one cleaning formula is an alkaline cleaning formula.

4. The comprehensive stain removal kit according to claim 1, wherein the at least one cleaning formula is a degreaser.

5. The comprehensive stain removal kit according to claim 1, further comprising:
a vapor impervious packet enclosing at least one of the at least one cleaning formula and the rinse solution; and
the packet includes identifying information.

6. The comprehensive stain removal kit according to claim 5, wherein the packet includes information to apply at least one of the at least one cleaning formula and the rinse solution.

7. The comprehensive stain removal kit according to claim 2, wherein the at least one cleaning formula includes acetic acid.

8. The comprehensive stain removal kit according to claim 2, wherein the at least one cleaning formula is oxalic acid.

9. The comprehensive stain removal kit according to claim 2, wherein the at least one cleaning formula includes hydrofluoric acid.

10. The comprehensive stain removal kit according to claim 3, wherein the at least one cleaning formula comprises ammonia.

11. The comprehensive stain removal kit according to claim 4, wherein the at least one cleaning formula is a citrus degreaser.

12. The comprehensive stain removal kit according to claim 4, wherein the at least one cleaning formula is a solvent based degreaser.

13. The comprehensive stain removal kit according to claim 1, wherein the at least one cleaning formula includes an organic detergent.

14. The comprehensive stain removal kit according to claim 1, wherein the at least one cleaning formula includes cleaning enzymes.

15. The comprehensive stain removal kit according to claim 1, further comprising cloths or webs as a medium for the at least one cleaning formula and rinse solution.

16. The comprehensive stain removal kit according to claim 15, wherein the webs are non-woven, embossed webs.

17. The comprehensive stain removal kit according to claim 15, wherein the webs are selected from the group consisting of treated fibers, natural fibers, synthetic fibers and micro fibers.

18. The comprehensive stain removal kit according to claim 15, wherein the webs are made from rayon and polyester.

19. A kit for use in removing stains from fabrics, comprising:
a cleaning formula for cleaning a stained fabric;
a rinse solution for rinsing the fabric after application of the cleaning formula;
a stain guide including information for treatment of particular stains through the application of a sequence of the cleaning formula and rinse solution; and
a super absorbent material for application to a side of the fabric opposite that to which a stain treatment is to be applied to absorb an applied cleaning formula, rinse solution and stain material.

20. A comprehensive stain removal kit, comprising:
at least three vapor impervious packets, each containing a different cleaning formula for cleaning a stained fabric;
at least one vapor impervious packet containing a rinse solution for rinsing the fabric after application of one or more cleaning formulas;
a stain guide including information for treatment of particular stains through the application of a sequence of at least one cleaning formula and rinse solution; and
a super absorbent material for application to a side of the fabric opposite that to which a stain treatment is to be applied to absorb the applied cleaning formula, stain material and rinse solution.

21. A kit according to claim 20, wherein the cleaning formulas include an acidic, alkaline and degreaser cleaning formula.

22. A kit according to claim 20, wherein the rinse solution is distilled water.

23. A kit according to claim 20, further including a packet for containing the super absorbent material.

24. A kit according to claim 20, wherein the packets are labeled with application information.
